(19) United States
(12) Patent Application Publication
(10) Pub. No.: US 2005/0050524 A1
(43) Pub. Date: Mar. 3, 2005

(54) Generating software test information

(75) Inventors: Andrew James Booker, Cambridge (GB); Hedley James Francis, Newmarket (GB); Gareth Michael Vaughan, Ely (GB)

Correspondence Address: NIXON & VANDERHYE, PC, 1100 N GLEBE ROAD, 8TH FLOOR, ARLINGTON, VA, 22201-4714, US

(73) Assignee: ARM Limited, Cambridge (GB)

(21) Appl. No.: 10/647,106

(22) Filed: Aug. 25, 2003

(51) Int. Cl. G06F 9/44

(52) U.S. Cl. 717/130; 717/134

(57) ABSTRACT

A method and apparatus for generating software test information is disclosed. The method comprises the steps of: a) generating, from a sequence of instructions, at least one of which includes a condition code, a corresponding sequence of generated instructions, for selected instructions having a condition code the corresponding generated instruction being a predetermined generated instruction having a corresponding condition code; b) executing, on a target processor, the sequence of generated instructions; and c) when during the step (b) the predetermined generated instruction is encountered, determining with reference to status information associated with the operation of the target processor whether the condition code of the predetermined generated instruction is satisfied and, if so, replacing the predetermined generated instruction with the corresponding instruction from the sequence of instructions so as to cause the corresponding instruction to be executed. Providing a condition code with the generated instruction reduces the time taken to determine whether that condition code is satisfied. This is because it is possible to make the determination without invoking a software handler routine and instead the faster target processor hardware can be used. Hence, the performance when generating software test information is significantly improved.

### BACKGROUND OF THE INVENTION

1. Field of the Invention

The present invention relates to techniques for generating software test information. In particular, embodiments of the present invention relate to techniques for generating statistical information relating to the operation of software code when tested on a target processor.

2. Description of the Prior Art

Techniques for generating test information for software are known. Such techniques seek to provide quantitative information relating to the operation of the program code when executed. Two such techniques are known as “code coverage” and “profiling”. In the code coverage technique, the percentage of the total number of instructions of program code which are executed when the program is run is determined. For example, should the program code contain ‘X’ instructions, then if ‘Y’ instructions are executed when the program code is run (normally during debug or other testing) then the percentage of code coverage is calculated to be (Y/X)*100. In the profiling technique, the total number of times each of the X instructions is executed is also determined. It will be appreciated that both the code coverage and the profiling techniques can provide a quantitative indication of the extent of code testing or debugging.

A number of different approaches have been developed which implement the above techniques. One such implementation is illustrated with reference to FIG. 1. A computing device 10, such as a personal computer, is provided. An instruction set emulator 12, which is a software program which models the operation of a particular predetermined processor, is loaded onto the computing device 10. Also loaded onto the computing device 10 is the original opcode 14 of the program code to be analysed. From this original opcode 14, an analysis module of the instruction set emulator 12 produces generated opcode 16. In order to produce the generated opcode 16, the analysis module substitutes a special instruction (SPI) for each instruction in the original opcode 14. Hence, in the generated opcode 16, every instruction is initially a SPI.

In order to generate code coverage information the instruction set emulator 12 executes the generated opcode 16. On the occurrence of a special instruction the instruction set emulator 12 will invoke a special instruction handler within the analysis module which refers to the corresponding original instruction in the original opcode 14.

The instruction may be conditional and, in which case, may contain a condition code. The processor will typically maintain a number of flags which provide state information. The condition code indicates the conditions that those flags that must satisfy for the associated instruction to be executed. Such condition codes include EQ/NE (equal/not equal), CS/CC (carry set/carry clear), PL/MI (positive/negative), AL (always), etc. Hence, by way of example, in the ARM (trademark) instruction set, the condition code EQ/NE requires that the zero condition flag (‘Z’ flag) must be set/cleared respectively for the instruction to be executed; the Z flag is set if the result of the last condition flag setting instruction was zero. Similarly, the condition code PL/MI requires that the negative condition flag (‘N’ flag) must be cleared/set respectively for the instruction to be executed; the N flag is set if the result of the last condition flag setting instruction was negative. It will be appreciated that condition codes may require that particular combinations of flags must meet particular conditions for the instruction to be executed.

If it is determined that the instruction in the original opcode 14 is one which would have been executed by the processor (i.e. the condition code is satisfied), then the special instruction is replaced by the corresponding original instruction from the original opcode 14. The instruction set emulator 12 then executes that original instruction and proceeds to the next instruction. If, on the other hand, it is determined that the instruction in the original opcode 14 is one which would not have been executed by the processor (such as may occur, for example, with a branch instruction, where the branch conditions were not met), then the special instruction is not replaced by the corresponding original instruction from the original opcode 14 and the instruction set emulator 12 proceeds to the next instruction. This process continues with special instructions being replaced by the original instructions, when appropriate.

Once the execution of the program code has completed, or it is stopped, it is possible to determine which instructions have not been executed since these instructions are still represented by a special instruction. Accordingly, the analysis module within the instruction set emulator 12 can generate code coverage information relating to the operation of the whole or portions of the program code being analysed.

In order to generate profiling information, the instruction set emulator 12 executes the generated opcode 16. On the occurrence of a special instruction the instruction set emulator 12 will invoke the special instruction handler within the analysis module which refers to the original opcode 14. If it is determined that the instruction in the original opcode 14 is one which would have been executed by the processor (i.e. the condition code is satisfied), then that special instruction is replaced by the corresponding original instruction from the original opcode 14, a counter associated with that instruction is incremented and the preceding instruction in the generated opcode 16 is replaced by a special instruction. The instruction set emulator 12 then executes that original instruction and proceeds to the next instruction. Replacing the preceding instruction in the generated opcode 16 with a special instruction ensures that the next time that that preceding instruction is to be executed the special instruction handler is once again activated.

If, on the other hand, it is determined that the instruction in the original opcode 14 is one which would not have been executed by the processor, (i.e. the condition code is not satisfied) then that special instruction is not replaced by the corresponding original instruction from the original opcode 14, the preceding instruction in the generated opcode 16 is replaced by a special instruction and the instruction set emulator 12 then proceeds to the next instruction, and so on.

Once the execution of the program code has completed, or it is stopped, it is possible to determine the number of times each instruction has been executed by referring to their associated counters. Accordingly, the analysis module within the instruction set emulator 12 can generate profiling information relating to the operation of the whole or portions of the program code being analysed.

Whilst it will be appreciated that this implementation is extremely flexible since the instruction set emulator 12 is often available prior to the processor hardware itself being manufactured, it is extremely slow since the operation of the processor is being simulated using software.

Accordingly, an alternative implementation exists as illustrated in FIG. 2. A processor core 20 is coupled to a memory 22 and a debugger 24. The memory 22 is coupled to the processor core 20 using a bus 21. The processor core 20 is coupled to the debugger 24 by a bus 23. The processor core 20 is the hardware operable to support and execute the program code to be analysed. The debugger 24 is provided in the form of a personal computer or other computing device which runs debugger software. The debugger software has access to the original opcode 14 to be analysed.

Generated opcode 26 is produced. This generated opcode 26 is loaded into the memory 22 for execution by the processor core 20. However, in this case, instead of special instructions being provided for each instruction of the original opcode 14, the original opcode 14 is reproduced in the generated opcode 26 and a break point flag is set for each generated instruction. Hence, each instruction in the generated opcode 26 is identical to the corresponding instruction in the original opcode 14, but with a break point flag set.

In order to generate code coverage information, when the generated opcode 26 is executed by the processor core 20 and an instruction with a break point flag set is encountered, the processor core 20 halts its operation and activates the debugger 24. The debugger 24 assumes control and any data (such as register values, flags or other architectural state) required by the debugger 24 is then passed over the bus 23. The debugger 24 then determines whether the instruction is one which would have been executed by the processor core 20 (by checking whether or not the condition code is satisfied) and, if so, will arrange for the break point flag associated with that instruction to be cleared. If, on the other hand, it is determined that the instruction is one which would not have been executed by the processor core 20, then the break point flag associated with that instruction remains set. The debugger 24 will then instruct the processor core 20 over the bus 23 to resume operation. If the break point flag is cleared then the processor core 20 will execute that instruction; otherwise the processor core 20 will proceed on to the next instruction. This process continues with break point flags being cleared as appropriate in order to allow associated instructions to be executed.

Once the execution of the program code has completed, or it is stopped, it is possible to determine which instructions have not been executed since the break point flags associated with these instructions are still set. Accordingly, the memory 22 can be accessed in order to determine code coverage information relating to the operation of the whole or portions of the program code being analysed.

In order to generate profiling information, when the generated opcode 26 is executed by the processor core 20 and an instruction with a break point flag set is encountered, the processor core 20 halts its operation and activates the debugger 24. The debugger 24 assumes control and any data (such as register values, flags or other architectural state) required by the debugger 24 is then passed over the bus 23. The debugger 24 then determines whether the instruction is one which would have been executed by the processor core 20 (by checking whether or not the condition code is satisfied) and, if so, will arrange for the break point flag associated with that instruction to be cleared. Furthermore, a counter associated with that instruction is incremented and the break point flag associated with the preceding instruction is set. If, on the other hand, it is determined that the instruction is one which would not have been executed by the processor core 20, then the break point flag associated with that instruction remains set and the break point flag associated with the preceding instruction is set. The debugger 24 will then instruct the processor core 20 over the bus 23 to resume operation. If the break point flag is cleared then the processor core 20 will execute that instruction, otherwise the processor core 20 will proceed on to the next instruction, and so on.

Once the execution of the program code has completed, or it is stopped, it is possible to determine which instructions have been executed by referring to the counters associated with each instruction. Accordingly, profiling information can be generated relating to the operation of the whole or portions of the program code being analysed.

In situations where insufficient numbers of breakpoint flags are available, the technique described with reference to FIG. 1 could be implemented on the apparatus of FIG. 2, with the debugger 24 being activated each time a special instruction is encountered. Similarly, the technique described with reference to FIG. 2 could be implemented on the apparatus of FIG. 1, with a handler being activated each time a breakpoint flag is encountered.

It will be appreciated that since in the FIG. 2 arrangement the generated opcode 26 is now being run on the processor core 20 instead of being simulated by software, this implementation is much quicker than the implementation shown in FIG. 1. However, this implementation is still comparatively slow since the operation of the processor core 20 must be halted each time a set break point flag is encountered. Also, any information required by the debugger 24 to check, for example, whether the condition code is satisfied must be passed from the processor core 20 over the bus 23. Furthermore, the operation of the debugger 24 is slow in comparison to that of the processor core 20.

Accordingly, a third implementation is known, as illustrated with reference to FIG. 3. This implementation is similar to that described in FIG. 1, but is executed on the processor core 20 instead of the computing device 10. The processor core 20 is coupled to the memory 22 via the bus 21. The original opcode 14 together with the generated opcode 16 is stored in the memory 22. A handler routine 30 is also stored in the memory 22 which is operable by the processor core 20 to generate code coverage and profiling information using the program code 14 and the generated opcode 16.

The processor core 20 retrieves the first instruction of the generated opcode 16. The processor core 20 determines whether that instruction is a special instruction and, if so, then the handler routine 30 is invoked; otherwise, the processor core 20 executes the instruction and then retrieves the next instruction.

Once activated, the handler routine 30 refers to the original opcode 14 and checks the condition code of the corresponding original instruction. The handler routine 30 then determines whether the original instruction would have been executed by comparing its condition code with the current status flags of the processor core 20. If the handler routine 30 determines that the original instruction would have been executed, then it replaces the special instruction with the original instruction. The handler routine 30 is then exited. The processor core 20 hardware can then execute the original instruction which has just replaced the special instruction. If the handler routine 30 determines that the original instruction would not have been executed, then handler routine 30 is then exited and the processor core 20 hardware retrieves the next instruction. This process continues until either the operation of the program code completes or the execution of the program code is interrupted.

In this way it will be appreciated that only those instructions which would have been executed are included when producing code coverage information. This is because those instructions which would not have been executed are not replaced and remain as special instructions.

In order to generate profiling information, the processor core 20 retrieves the first instruction of the generated opcode 16. Should that instruction be a special instruction then the handler routine 30 is invoked; otherwise, the processor core 20 executes the instruction and then retrieves the next instruction.

Once activated, the handler routine 30 refers to the original opcode 14 and checks the condition code of the corresponding original instruction. The handler routine 30 then determines whether the original instruction would have been executed by comparing the condition code with the current status flags of the processor core 20. If the handler routine 30 determines that the original instruction would have been executed, then it replaces the special instruction with the original instruction, increments a counter associated with that instruction and replaces the preceding instruction with a special instruction. The handler routine 30 is then exited. The processor core 20 hardware then executes the original instruction which has just replaced the special instruction. If the handler routine 30 determines that the original instruction would not have been executed, the preceding instruction is replaced with a special instruction and the handler routine 30 is then exited. The processor core 20 hardware then retrieves the next instruction.

Once the execution of the program code has completed, or it is stopped, it is possible to determine which instructions have been executed by referring to the counters associated with each instruction in order to generate the profiling information.

It will be appreciated that this approach provides improved performance. This is because the implementation only uses the processor core 20 which is faster than using an emulator or having to activate a debugger. However, significant time can still be taken to generate information relating to the operation of software. The time taken to generate the information by activating the handler routine 30 can have an adverse impact on the operation of the software code, particularly in real-time systems, and can cause the software code to behave differently to its normal operation.

Accordingly, it is an object of the present invention to provide an improved technique for generating information relating to the operation of software.

### SUMMARY OF THE INVENTION

Viewed from a first aspect, the present invention provides a method of generating software test information, the method comprising the steps of: a) generating, from a sequence of instructions, at least one of which includes a condition code, a corresponding sequence of generated instructions, for selected instructions having a condition code the corresponding generated instruction being a predetermined generated instruction having a corresponding condition code; b) executing, on a target processor, the sequence of generated instructions; and c) when during said step (b) said predetermined generated instruction is encountered, determining with reference to status information associated with the operation of the target processor whether the condition code of the predetermined generated instruction is satisfied and, if so, replacing the predetermined generated instruction with the corresponding instruction from the sequence of instructions so as to cause the corresponding instruction to be executed.

The present invention recognises that because the steps followed when generating information for, for example, code coverage or profiling are typically repeated many times then any improvement in the time taken to perform these method steps can significantly reduce the overall time taken to generate the required information. The inventors of the present invention recognised that in the prior art approaches, the time taken when having to check whether a condition code is satisfied can be significant. The reason that this time is significant is that the original instruction needs to be referred to, as does the status of the target processor, in order to determine whether the condition code is satisfied. This determination is performed by a handler routine which because this is implemented using software increases the time taken. Hence, in the present invention, when the sequence of generated instruction is produced, a condition code is provided for each generated instruction, where appropriate. Providing a condition code with the generated instruction reduces the time taken to determine whether that condition code is satisfied. This is because it is possible to make the determination using the generated instruction without having to invoke a software handler routine to perform the additional steps of referring to the original instruction as required in the prior art approaches. Hence, if the condition is not satisfied then the software handler need not be invoked since the original instruction need not be referred to, which has been found to significantly improve performance when generating software test information. Also, in embodiments, the determination can be made by the target processor hardware instead of using software, which it will be appreciated further reduces the time taken. Hence, the operation of time-critical software code, such as can be found in real-time systems, is more likely to function correctly, unaffected by the generation of the software test information

In one embodiment, each instruction of the sequence of instructions includes a condition code.

Accordingly, for instruction sets, such as the ARM (trademark) instruction set, in which a condition code may be applied to each instruction, each generated instruction is provided with a corresponding condition code. It will be appreciated that in such instruction sets, a condition code may be provided which indicates that the associated instruction will always be executed (in effect making the instruction unconditional).

In one embodiment, the condition code is an instruction qualifier which prevents the instruction from being executed by the target processor unless the status information satisfies the condition code.

Hence, only when the status information associated with the target processor matches that of the condition code can the target processor execute the instruction; otherwise, the target processor is prevented from executing the instruction.

In one embodiment, the status information is predetermined architectural state associated with the target processor and the condition code specifies a status of the predetermined architectural state that must be met in order for the instruction to be executed.

Examples of architectural state include the contents of registers, the values stored at particular memory locations or the status of various buses, paths, lines, flags or modules within the target processor or to which the target processor is coupled.

In one embodiment, the predetermined generated instruction is an instruction which is not recognised by the target processor.

Using an instruction which is not recognised by the target processor (e.g. an instruction which has not been designated as part of the instruction set) provides a convenient mechanism to halt the operation of the target processor in order to enable the required information to be generated.

In one embodiment, the step a) comprises the step of: generating, from the sequence of instructions, a sequence of generated instructions, a predetermined generated instruction being generated for each instruction in the sequence of instructions.

Hence, for each instruction in the sequence, a predetermined instruction is generated. It will be appreciated that this provides a one to one correspondence between the original instructions and generated instructions, each of which being the predetermined generated instruction.

In an alternative embodiment, the step a) comprises the steps of: a1) partitioning the sequence of instructions into a number of instruction groups, each instruction group including one or more instructions; and a2) generating said predetermined generated instruction for one instruction in each of the instruction groups.

Each instruction group typically consists of a sequence of instructions with the same condition code. The instruction group may, however, consist of just one instruction. Accordingly, instead of providing a generated instruction for each instruction, just one generated instruction need be provided for each instruction group from which, for example, code coverage information can readily be derived. By not converting all the instructions to predetermined generated instructions the time taken to generate software test information is reduced.

In one embodiment the step a2) comprises: generating said predetermined generated instruction for the last instruction in each of the instruction groups.

In one embodiment, the predetermined generated instruction provides information relating to the number of instructions in that instruction group.

In one embodiment, the step c) further comprises the step of: incrementing a coverage counter when the condition code of the predetermined generated instruction is satisfied to provide an indication that said corresponding instruction will be executed.

By incrementing a counter, the need to parse the sequence of generated instructions to determine the number of predetermined generated instructions replaced is obviated and instead the counter can provide the required code coverage information.

In one embodiment, the step c) further comprises the step of: incrementing a counter associated with the corresponding instruction when the condition code of the predetermined generated instruction is satisfied to provide an indication that the corresponding instruction will be executed.

By incrementing a counter associated with that particular instruction, profiling information can readily be provided.

As mentioned previously, when a condition code is satisfied and the instruction is a predetermined generated instruction then that instruction is replaced with the corresponding instruction from the sequence of instructions, a counter associated with that instruction is incremented and the corresponding instruction is executed. Hence, the predetermined generated instruction has been replaced with the corresponding original instruction. When generating profiling information it is necessary to increment a counter each time the instruction is executed. It will be appreciated that since the predetermined generated instruction has been replaced, when this instruction is next encountered it will typically be directly executed by the target processor without the counter being further incremented.

Accordingly, in one embodiment the step c) further comprises the step of: replacing a preceding instruction in said sequence of generated instructions with the predetermined generated instruction having a corresponding condition code.

Replacing the preceding instruction in the generated sequence of instructions ensures that, during profiling, each time that an instruction is encountered it is a predetermined generated instruction which causes profiling information to be generated since the counter associated with that instruction is incremented. If the preceding instruction was not replaced then the next time that the instruction was encountered by the target processor then the instruction would simply be executed and no further profiling information for that instruction would be generated since the associated counter would not be incremented any further.

In one embodiment the step c) further comprises the step of: executing the corresponding instruction on the target processor.

Viewed from a second aspect, the present invention provides an apparatus for generating software test information, the apparatus comprising: instruction generation logic operable to generate, from a sequence of instructions, at least one of which includes a condition code, a corresponding sequence of generated instructions, for selected instructions having a condition code the corresponding generated instruction being a predetermined generated instruction having a corresponding condition code; a target processor operable to execute the sequence of generated instructions and to identify the occurrence of the predetermined generated instructions; and determination logic operable, when the predetermined generated instruction is encountered by the target processor, to determine with reference to status information associated with the operation of the target processor whether the condition code of the predetermined generated instruction is satisfied and, if so, to replace the predetermined generated instruction with the corresponding instruction from the sequence of instructions so as to cause the corresponding instruction to be executed.

Viewed from a third aspect, the present invention provides a computer program product operable, when executed on a computer, to generate software test instructions by performing the step of: generating, from a sequence of instructions, at least one of which includes a condition code, a corresponding sequence of generated instructions, for selected instructions having a condition code the corresponding generated instruction being a predetermined generated instruction having a corresponding condition code.

Viewed from a fourth aspect, the present invention provides a computer program product operable, when executed on a computer, to generate software test information by performing the steps of: a) executing, on a target processor, a sequence of generated instructions; and b) when a predetermined generated instruction is encountered during the step (a), determining with reference to status information associated with the operation of the target processor whether a condition code of that predetermined generated instruction is satisfied and, if so, replacing the predetermined generated instruction with a corresponding instruction from a sequence of instructions so as to cause the corresponding instruction to be executed.

### BRIEF DESCRIPTION OF THE DRAWINGS

The present invention will be described further, by way of example only, with reference to preferred embodiments thereof as illustrated in the accompanying drawings, in which:

FIG. 1 illustrates a simulation implementation for generating software test information;

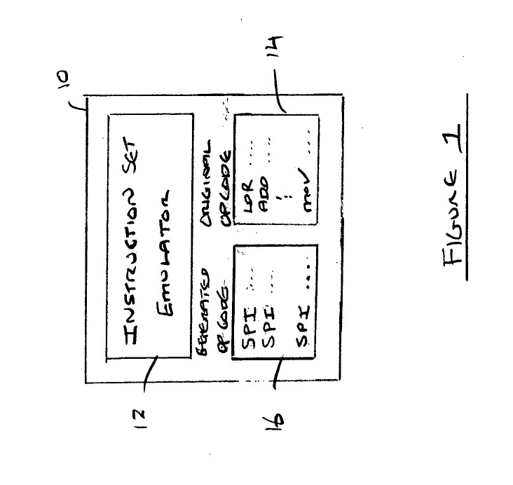

FIG. 2 illustrates a breakpoint implementation for generating software test information;

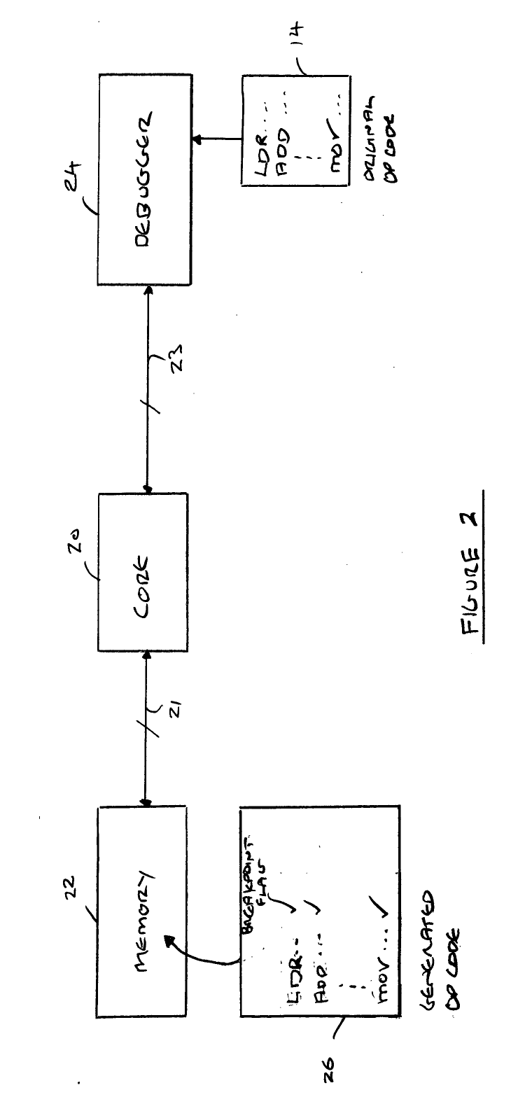

FIG. 3 illustrates an implementation for generating software test information on a processor core;

FIG. 4A illustrates an apparatus for generating software test information according to one embodiment of the present invention;

FIG. 4B illustrates the operation of the apparatus of FIG. 4A when generating software test information;

FIG. 5 illustrates components of example instructions; and

FIG. 6 illustrates the arrangement of instruction groups.

### DESCRIPTION OF PREFERRED EMBODIMENTS

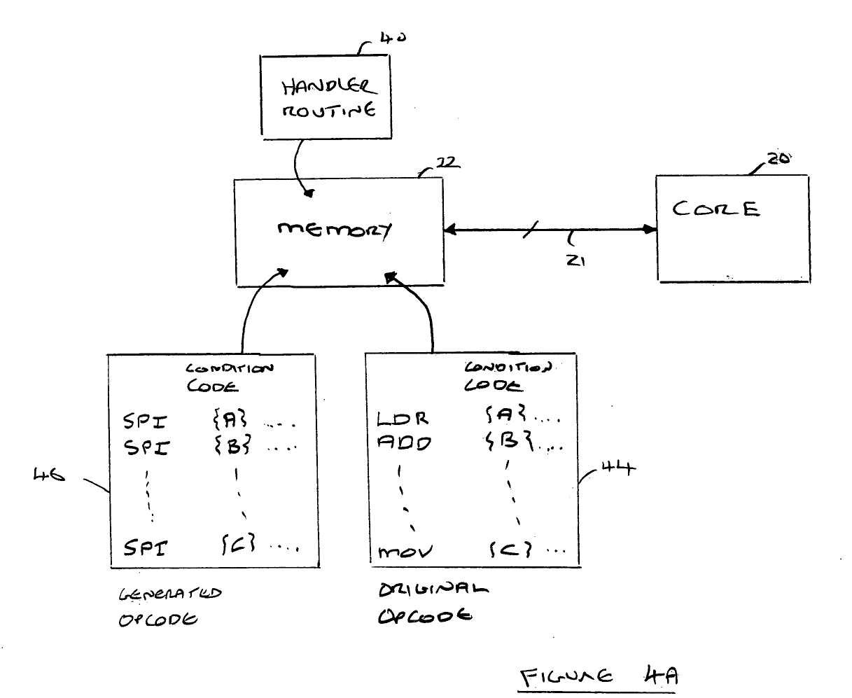

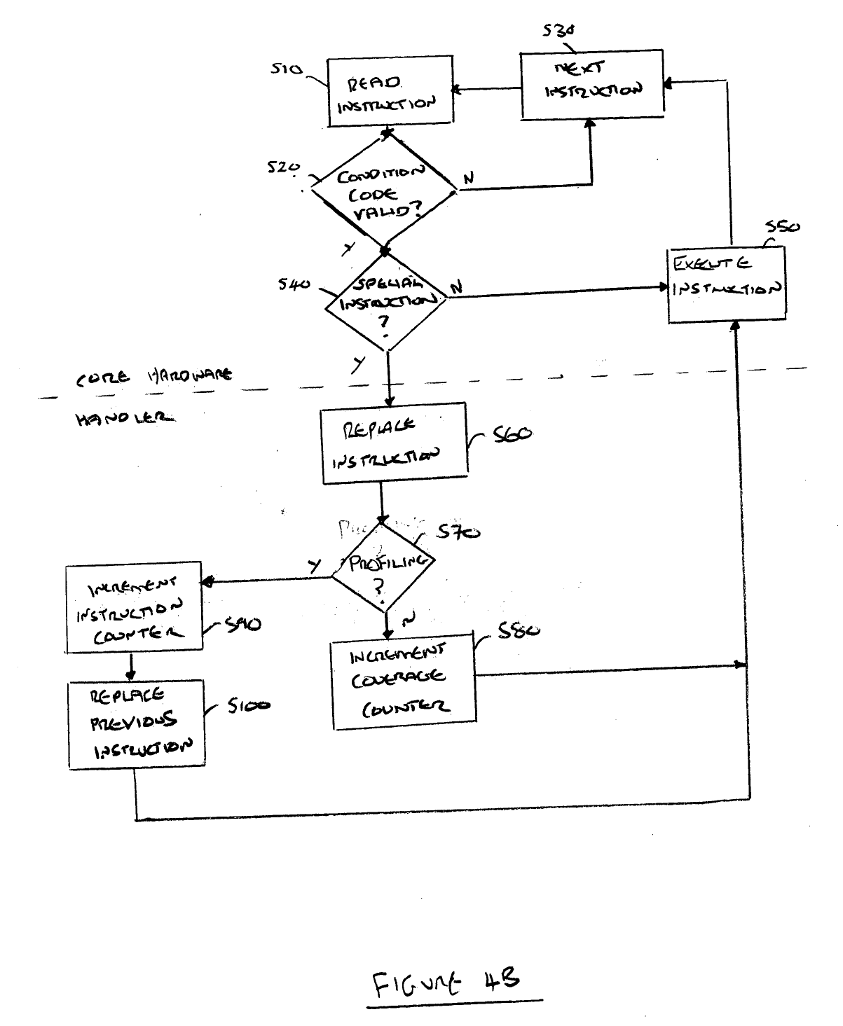

FIG. 4A illustrates an apparatus for generating software test information according to an embodiment of the present invention. The software test information includes code coverage information and profiling information.

The processor core 20 is coupled to the memory 22 via the bus 21. Original opcode 44 together with the generated opcode 46 is stored in the memory 22. A handler routine 40 is also stored in the memory 22 and is operable to generate code coverage information using the program code 44 and the generated opcode 46.

The original opcode 44 includes instructions (LD, i.e. load from memory into a register; ADD, i.e. add the contents of one register to another and place the result in a register; MOV, i.e. move the contents of one register into another, etc.) together with condition codes associated with those instructions (A, B, C, etc which represent particular condition codes described earlier). Whilst it is possible that not all instructions require a condition code (i.e. the instruction is unconditional and will always be executed), in this embodiment, which utilises the ARM instruction set, all instructions have a condition code. Hence, unconditional instructions are assigned the condition code AL (always) to indicate that these instructions are always to be executed.

From the original opcode 44, generated opcode 46 is produced. It will be appreciated that the generated opcode 46 will typically be produced by another software program residing in the memory 22 or in an external device. In the generated opcode 46 each instruction is replaced with a “special instruction” (SPI), which is an instruction which is not recognised by the processor core 20. Hence, the special instruction is selected to be one which is not designated in the instruction set. As mentioned previously, selecting an instruction which is not part of the instruction set prevents the processor core 20 from executing the instruction and causes the handler routine 40 to be invoked so that test information can be generated, where appropriate, to indicate that an instruction has been executed. Each special instruction is also provided with the condition code of the corresponding original instruction. For example, the generated instruction for: MOV {EQ} R1, R2 would be SPI {EQ}; LDR {AL} R3, [R1] would be SPI {AL}; ADD {MI} R4, R5, R6 would be SPI {MI}; etc.

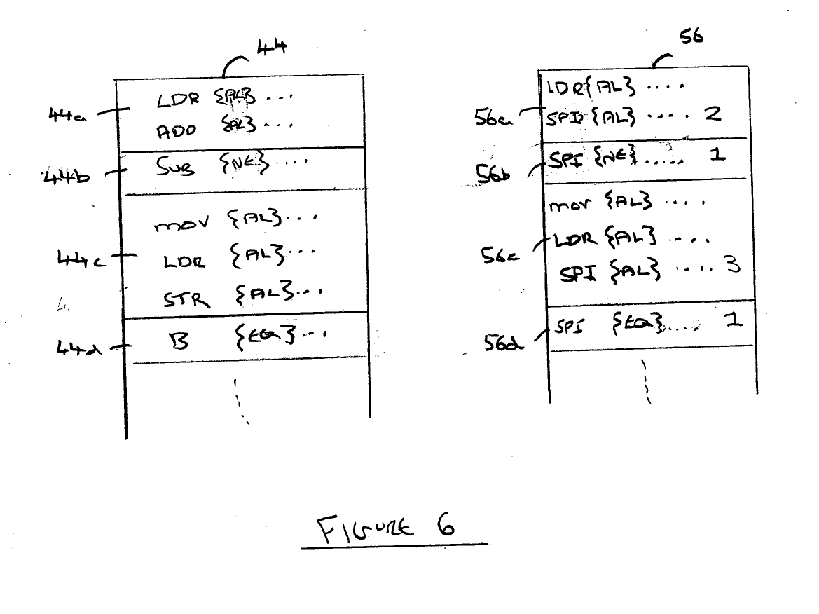

As will be described in more detail below with reference to FIG. 6, it is not necessary for every instruction to be replaced by a special instruction in the generated opcode 46. Sequences of instructions which will always be executed may remain in their original form with usually only the next conditional instruction being converted to a special instruction.

Once produced, the generated opcode 46 is stored in the memory 22 and the processor core 20 operates as illustrated in FIG. 4B.

At step S10, the processor core 20 reads the first instruction in the generated opcode 46, in this example SPI {A}.

At step S20, the processor core 20 checks whether the condition code associated with the instruction is satisfied by checking the architectural state of the processor core 20. In this embodiment, which utilises an ARM architecture processor core, supporting the ARM instruction set, most instructions can have a condition code associated therewith. Accordingly, the core hardware automatically checks prior to execution whether the condition code is valid. Hence, not only is this step performed in hardware (which can perform the step much faster than software), but the step would always be performed, irrespective of whether the result was used or not. Hence, no delay is introduced by performing this step.

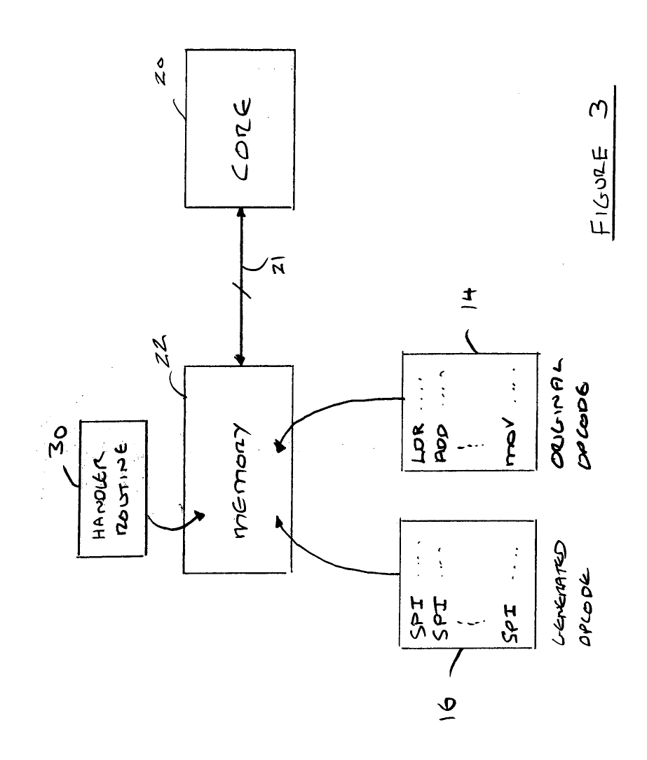

If the condition code is not valid, meaning that the instruction will not be executed and hence no code coverage or profiling information should be generated, then processing proceeds straight to step S30 where the next instruction to be read is identified (i.e. SPI {B}), all of which is performed by the processor core 20 hardware without the need to invoke a handler routine. This should be contrasted with the prior art approach of FIG. 3 where, as mentioned above, in order to determine whether the condition code is valid, the special instruction had to be identified; then the operation of the processor core 20 suspended whilst a handler routine was invoked; then the corresponding original instruction identified, together with its condition code; and only then could the condition code be checked against the architectural state of the processor core 20. It will be appreciated that many more steps had to be performed and that most of these steps were performed using software which is significantly slower than a hardware implementation. Also, these additional steps may often be unnecessary in the situation where the conclusion of the determination is that the condition code is not valid and hence the instruction would not be executed anyway.

If the condition code is valid, meaning that the instruction will be executed and code coverage or profiling information will need to be generated, then processing proceeds to step S40 where the processor core 20 hardware determines whether the instruction is a special instruction or not.

If the instruction is a special instruction, then processing proceeds to step S60 where the handler routine 40 is invoked to replace the current generated instruction, in this example SPI {A} . . . with the original instruction which is LDR {A} . . . and processing proceeds to step S70. It will be appreciated that many techniques could be utilised to determine the corresponding original instruction in the original opcode 44.

At step S70, it is determined whether profiling information is to be collected or not. This determination is made by the handler routine 40, dependent on selections made by the user causing the test information to be generated. It will be appreciated that step S70 has only been included for convenience of explanation of the code coverage and profiling information techniques. For efficiency reasons, a determination of whether profiling information is to be collected or not may be made at the time of generating the software to be executed by the processor core 20. Making such a determination enables only those steps required to be executed to be included in the software code in order to reduce the size of the software code and to increase execution speed (i.e. if no profiling information is to be generated then steps S70, S90 and S100 may be excluded).

If no profiling information is to be collected, then processing proceeds to step S80 where a coverage counter is incremented. It will be appreciated that incrementing the coverage counter removes the need to parse the generated opcode 46 for special instructions at the end of testing in order to determine the code coverage value. Instead, the number of instructions executed can be determined directly from the coverage counter. Processing then proceeds to step S50 where the processor core 20 resumes normal processing and the original instruction which replaced the special instruction is executed.

If profiling information is to be collected, then processing proceeds to step S90 where a counter associated with that particular instruction is incremented to indicate that that instruction will be executed. Next, at step S100, the previous instruction is replaced with a special instruction having the same condition code. This previous instruction is the previous instruction which was executed. This previous instruction may not be the logically preceding instruction in memory, but may be located elsewhere if that instruction had, for example, caused non-sequential processing of instructions (such as would occur as a result of a direct or indirect branch). It will be appreciated that many different techniques could be used to identify the preceding instruction. In this embodiment, the handler routine 40 stores details of the preceding instruction. As mentioned previously, replacing the instruction with a special instruction ensures that when that instruction comes to be executed again, the handler routine 40 is activated to ensure that further profiling information is generated. Once the instruction has been replaced then processing proceeds to step S50 where the processor core 20 resumes normal processing and the original instruction which replaced the special instruction is executed.

If, on the other hand, it is determined at step S40 that the instruction is not a special instruction, then the instruction is executed by the processor core 20 hardware at step S50. Such a situation would occur when either the generated instruction is the same as the original instruction, as will be described in more detail below with reference to FIG. 6. Alternatively, this situation may occur where code coverage information is being generated and the instruction has previously been executed.

This process continues until the execution of the generated opcode 46 has completed or is interrupted. Thereafter, it is possible, through examination of the respective counters to determine code coverage and/or profiling information. As described previously, the code coverage can be calculated by dividing the value of the code coverage counter by the total number of instructions in the generated opcode 46 and then multiplying the result by 100 to provide a percentage. The profiling information is determined simply by examining the values of the counters associated with each instruction in order to determine the number of times that instruction has been executed.

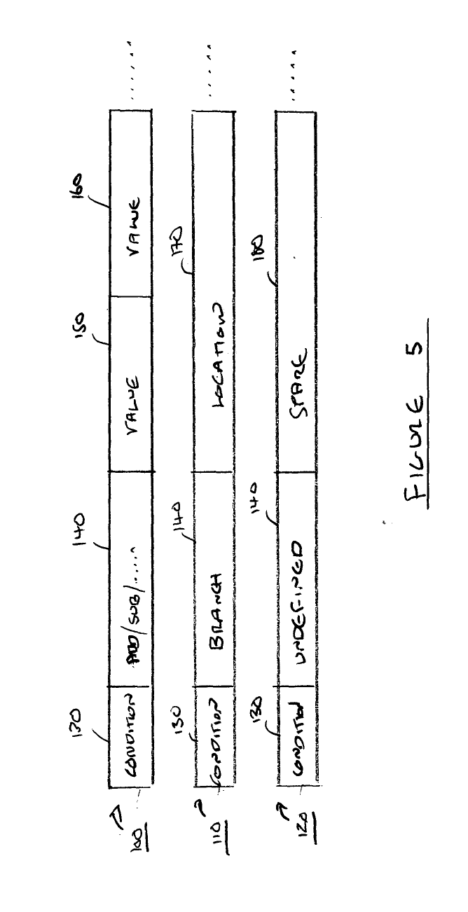

FIG. 5 illustrates components of example 32-bit instructions as defined by the ARM instruction set.

Instruction 100 illustrates the configuration of parts of load/store/add/subtract/etc. instructions which comprise a condition code portion 130 (which indicates the condition code to be applied to this instruction), an operation indicator portion 140 (which indicates whether the instruction is a load/store/add/subtract/etc.) and at least two value portions 150, 160 (which indicate registers containing the operand values on which the operation is to be performed). Instruction 110 illustrates the configuration of relevant parts of branch instructions which comprise a condition code portion 130 (which indicates the condition code to be applied to this instruction), an operation indicator portion 140 (which indicates that the instruction is a branch) and a location portion 170 (which indicates a register containing the location in memory which is the destination of the branch).

Instruction 120 illustrates the configuration of relevant parts of special instructions which comprise a condition code portion 130 (which indicates the condition code to be applied to this instruction), an operation indicator portion 140 (which indicates that the instruction is an undefined or special instruction) and a spare portion 180 (which can contain any required information).

The operation indicator portion 140 of the instruction 120 is selected to have a value which is not assigned within the instruction set. The spare portion 180 of the instruction 120 can be arranged to include further information which may be used when generating code coverage or profiling information when using an instruction grouping technique as will be described in more detail below with reference to FIG. 6.

In order to further improve execution speed, it is possible to group instructions together according to the following algorithm:—a) group together instructions with the same condition code; b) split these grouped instructions into smaller groups at any branch instruction or branch target; c) replace the last instruction in each group with a special instruction; and d) optionally append additional information to the special instruction to indicate the number of instructions in that group. Using this technique further reduces the time taken to generate software test information.

Hence, in the example shown in FIG. 6, there are four instruction groups 44a, 44b, 44c, 44d in the original opcode 44. In the instruction group 44a, the LDR and ADD instructions each have the same {AL} condition code indicating that they will always be executed. In the instruction group 44b is SUB {NE} which is a single instruction having that condition code. Similarly, in the instruction group 44c, the MOV, LDR and STR instructions each have the same {AL} condition code indicating that they will always be executed. In the instruction group 44d is B {EQ} which is a single instruction having that condition code. Accordingly, given that each instruction group contains instructions which have the same condition code, it will be appreciated that any steps taken to determine whether or not each of the instructions in the group will be executed are unnecessary since it is certain that if the last instruction is executed then all the previous instructions in the group will have been executed. Furthermore, for sake of illustration, if the instruction MOV, in instruction group 56c had been the branch target of another instruction then instruction group 56c would itself have been split into two instruction groups i.e. MOV in one instruction group and LDR and STR in another instruction group.

Hence, when using instruction groups, there is no need for all instructions in each group to be converted into special instructions in the generated opcode 56. Instead, only at least one instruction in the group need be converted. In this embodiment, the last instruction in the group is converted into a special instruction. By not converting every instruction, the time taken to generate test information is further reduced because the number of times that that the slower handler routine needs be activated is reduced. Hence, many more of the instructions can be dealt with directly by the faster processor core 20 hardware.

The last instruction in each group, when converted, is provided with additional information which enables code coverage and/or profiling information to be generated. The additional information may be encoded using the spare portion 180 of the instruction. This additional information typically indicates the number of instructions in that group. Hence, for instruction group 56a, 2 is encoded to indicate two instructions in that group; for instruction group 56b, 1 is encoded to indicate one instruction; for instruction group 56c, 3 is encoded to indicate three instructions; and for instruction group 56d, 1 is encoded to indicate one instruction.

Accordingly, it will be appreciated that the above provides an improved technique for generating software test information. One reason that the time taken to generate such information is significantly reduced is because the frequency at which a software handler needs to invoked is reduced. This is achieved by producing generated opcode in a form which enables the target processor hardware to determine whether or not each particular instruction will be executed, without having to invoke the software handler routine. By not having to invoke a slower software handler, it will be appreciated that the speed at which software test information can be produced is significantly increased. This approach has been found to have particular application in real-time systems where unduly delaying the execution of the original opcode can adversely affect the performance of the system and may cause the software code to operate in an incorrect (and, hence, unrepresentative) manner. Clearly, it will be appreciated that when testing software, it is necessary to cause the software under test to operate in a representative manner since this may otherwise provide misleading test information.

Although a particular embodiment of the invention has been described herein, it will be apparent that the invention is not limited thereto, and that many modifications and additions may be made within the scope of the invention. For example, various combinations of the features of the following dependent claims could be made with the features of the independent claims without departing from the scope of the present invention.

1. A method of generating software test information, said method comprising the steps of:
a) generating, from a sequence of instructions, at least one of which includes a condition code, a corresponding sequence of generated instructions, for selected instructions having a condition code the corresponding generated instruction being a predetermined generated instruction having a corresponding condition code;
b) executing, on a target processor, said sequence of generated instructions; and
c) when during said step (b) said predetermined generated instruction is encountered, determining with reference to status information associated with the operation of said target processor whether the condition code of said predetermined generated instruction is satisfied and, if so, replacing said predetermined generated instruction with said corresponding instruction from said sequence of instructions so as to cause said corresponding instruction to be executed.

2. The method of claim 1, wherein each instruction of said sequence of instructions includes a condition code.

3. The method of claim 1, wherein said condition code is an instruction qualifier which prevents the instruction from being executed by said target processor unless said status information satisfies said condition code.

4. The method of claim 1, wherein said status information is predetermined architectural state associated with said target processor and said condition code specifies a status of said predetermined architectural state that must be met in order for the instruction to be executed.

5. The method of claim 1, wherein said predetermined generated instruction is an instruction which is not recognised by said target processor.

6. The method of claim 1, wherein said step a) comprises the step of:
generating, from said sequence of instructions, a sequence of generated instructions, a predetermined generated instruction being generated for each instruction in the sequence of instructions.

7. The method of claim 1, wherein said step a) comprises the steps of:
a1) partitioning said sequence of instructions into a number of instruction groups, each instruction group including one or more instructions; and
a2) generating said predetermined generated instruction for one instruction in each of said instruction group.

8. The method of claim 7, wherein said step a2) comprises the step of:
generating said predetermined generated instruction for the last instruction in each of said instruction groups.

9. The method of claim 7, wherein said predetermined generated instruction provides information relating to the number of instructions in that instruction group.

10. The method of claim 1, wherein said step c) further comprises the step of:
incrementing a coverage counter when the condition code of the predetermined generated instruction is satisfied to provide an indication that said corresponding instruction will be executed.

11. The method of claim 1, wherein said step c) further comprises the step of:
incrementing a counter associated with said corresponding instruction when the condition code of the predetermined generated instruction is satisfied to provide an indication that said corresponding instruction will be executed.

12. The method of claim 11, wherein said step c) further comprises the step of:
replacing a preceding instruction in said sequence of generated instructions with said predetermined generated instruction having a condition code corresponding to said preceding instruction.

13. The method of claim 1, wherein said step c) further comprises the step of:
executing said corresponding instruction on said target processor.

14. An apparatus for generating software test information, said apparatus comprising:
instruction generation logic operable to generate, from a sequence of instructions, at least one of which includes a condition code, a corresponding sequence of generated instructions, for selected instructions having a condition code the corresponding generated instruction being a predetermined generated instruction having a corresponding condition code;
a target processor operable to execute said sequence of generated instructions and to identify the occurrence of said predetermined generated instructions; and
determination logic operable, when said predetermined generated instruction is encountered by said target processor, to determine with reference to status information associated with the operation of said target processor whether the condition code of said predetermined generated instruction is satisfied and, if so, to replace said predetermined generated instruction with said corresponding instruction from said sequence of instructions so as to cause said corresponding instruction to be executed.

15. The apparatus of claim 14, wherein each instruction of said sequence of instructions includes a condition code.

16. The apparatus of claim 14, wherein said condition code is an instruction qualifier which prevents the instruction from being executed by said target processor unless said status information satisfies said condition code.

17. The apparatus of claim 14, wherein said status information is predetermined architectural state associated with said target processor and said condition code specifies a status of said predetermined architectural state that must be met in order for the instruction to be executed.

18. The apparatus of claim 14, wherein said predetermined generated instruction is an instruction which is not recognised by said target processor.

19. The apparatus of claim 14, wherein said instruction generation logic is operable to generate, from said sequence of instructions, a sequence of generated instructions, a predetermined generated instruction being generated for each instruction in the sequence of instructions.

20. The apparatus of claim 14, wherein said instruction generation logic is operable to partition said sequence of instructions into a number of instruction groups, each instruction group including one or more instructions, and to generate said predetermined generated instruction for one instruction in each of said instruction group.

21. The apparatus of claim 20, wherein said instruction generation logic is operable to generate said predetermined generated instruction for the last instruction in each of said instruction groups.

22. The apparatus of claim 20, wherein said predetermined generated instruction provides information relating to the number of instructions in that instruction group.

23. The apparatus of claim 14, wherein said determination logic is operable to increment a coverage counter when the condition code of the predetermined generated instruction is satisfied to provide an indication that said corresponding instruction will be executed.

24. The apparatus of claim 14, wherein said determination logic is operable to increment a counter associated with said corresponding instruction when the condition code of the predetermined generated instruction is satisfied to provide an indication that said corresponding instruction will be executed.

25. The apparatus of claim 24, wherein said determination logic is operable to replace a preceding instruction in said sequence of generated instructions with said predetermined generated instruction having a condition code corresponding to said preceding instruction.

26. The apparatus of claim 14, wherein said determination logic is operable to cause the execution of said corresponding instruction on said target processor.

27. A computer program product operable, when executed on a computer, to generate software test instructions by performing the step of:
a) generating, from a sequence of instructions, at least one of which includes a condition code, a corresponding sequence of generated instructions, for selected instructions having a condition code the corresponding generated instruction being a predetermined generated instruction having a corresponding condition code.

28. The computer program product of claim 27, wherein each instruction of said sequence of instructions includes a condition code.

29. The computer program product of claim 27, wherein said condition code is an instruction qualifier which prevents the instruction from being executed by a target processor unless said status information satisfies said condition code.

30. The computer program product of claim 27, wherein said predetermined generated instruction is an instruction which is not recognised by said target processor.

31. The method of claim 27, wherein said step a) comprises the step of:
generating, from said sequence of instructions, a sequence of generated instructions, a predetermined generated instruction being generated for each instruction in the sequence of instructions.

32. The computer program product of claim 27, wherein said step a) comprises the steps of:
a1) partitioning said sequence of instructions into a number of instruction groups, each instruction group including one or more instructions; and
a2) generating said predetermined generated instruction for one instruction in each of said instruction group.

33. The computer program product of claim 32, wherein said step a2) comprises the step of:
generating said predetermined generated instruction for the last instruction in each of said instruction groups.

34. The computer program product of claim 32, wherein said predetermined generated instruction provides information relating to the number of instructions in that instruction group.

35. A computer program product operable, when executed on a computer, to generate software test information by performing the steps of:
a) executing, on a target processor, a sequence of generated instructions; and
b) when a predetermined generated instruction is encountered during said step (a), determining with reference to status information associated with the operation of said target processor whether a condition code of that predetermined generated instruction is satisfied and, if so, replacing said predetermined generated instruction with a corresponding instruction from a sequence of instructions so as to cause said corresponding instruction to be executed.

36. The computer program product of claim 35, wherein said condition code is an instruction qualifier which prevents the instruction from being executed by said target processor unless said status information satisfies said condition code.

37. The computer program product of claim 35, wherein said status information is predetermined architectural state associated with said target processor and said condition code specifies a status of said predetermined architectural state that must be met in order for the instruction to be executed.

38. The computer program product of claim 35, wherein said predetermined generated instruction is an instruction which is not recognised by said target processor.

39. The computer program product of claim 35, wherein said step b) further comprises the step of:
incrementing a coverage counter when the condition code of the predetermined generated instruction is satisfied to provide an indication that said corresponding instruction will be executed.

40. The computer program product of claim 35, wherein said step b) further comprises the step of:
incrementing a counter associated with said corresponding instruction when the condition code of the predetermined generated instruction is satisfied to provide an indication that said corresponding instruction will be executed.

41. The computer program product of claim 40, wherein said step c) further comprises the step of:
replacing a preceding instruction in said sequence of generated instructions with said predetermined generated instruction having a condition code corresponding to said preceding instruction.

42. The computer program product of claim 35, wherein said step c) further comprises the step of:
executing said corresponding instruction on said target processor.
